(19) United States
(12) Patent Application Publication
(10) Pub. No.: US 2015/0091810 A1
(43) Pub. Date: Apr. 2, 2015

(54) User Interface of an Electronic Apparatus for Adjusting Dynamically Sizes of Displayed Items

(71) Applicant: Yang Pan, Singapore (SG)

(72) Inventor: Yang Pan, Singapore (SG)

(21) Appl. No.: 14/040,727

(22) Filed: Sep. 30, 2013

Related U.S. Application Data
(62) Division of application No. 14/040,724, filed on Sep. 29, 2013.

(51) Int. Cl. G06F 3/041

(52) U.S. Cl. CPC G06F 3/041; G06F 2203/04108
USPC 345/173

(57) ABSTRACT

A user interface of a mobile device is provided for adjusting dynamically sizes of displayed items in response to a contactless movement of a user's finger relative to a display. In one aspect, sizes of a subgroup of items are enlarged when the finger is approaching but not yet touching the icons. It helps the user to make a more accurate selection. In another aspect, some contents of the next hierarchical level are displayed in accompanying with the enlarged size of at least one displayed item. Various embodiments are disclosed for a position sensing system including image, ultrasonic and thermal sensing systems for the mobile device.

### CROSS-REFERENCE TO RELATED APPLICATIONS

The present application is a division of patent application Ser. No. 14/040,724 filed on Sep. 29, 2013 by the same applicant.

### BACKGROUND

1. Field of Invention

This invention relates generally to user interface. More specifically, the invention relates to system and method for adjusting dynamically sizes of displayed items of a mobile computing and communication device.

2. Description of Prior Art

Mobile computing and communication devices have gained significant popularity in recent years. Users are using the mobile device such as, for example, iPhone, iPod and iPad from Apple Inc, Cupertino, Calif., to enjoy media assets and to access the Internet services. Methods for a user's interfacing with the devices have been developed. Graphical User Interface (GUI) based on touch-sensitive display has been adopted widely in recent years.

However, there is a problem associated with the use of GUI implemented with the touch-sensitive display. A user may not be able to align his or her finger to a displayed item when a size of the displayed item is small. It is not always possible to increase the size of the displayed item because a number of items need to be displayed on a display screen with a limited size.

It is, therefore, desirable to have a method and system to adjust the size of the displayed item in a dynamic manner. For example, at least some of the displayed items are enlarged when a user's finger is moving towards the displayed but not yet touching the screen.

### SUMMARY OF THE INVENTION

It is an object of the present invention to providing a system and method for adjusting dynamically sizes of displayed items in response to a contactless movement of a user's finger.

It is another object of the present invention to have a system and method providing a means of previewing contents of next hierarchical level with an enlarged displayed item in response to a contactless movement of a user's finger.

It is yet another object of the present invention to have a position sensing system integrated with the electronic apparatus pertaining to determining a position of a user's finger relative to the display.

It is yet another object of the present invention to have a position sensing system integrated with the electronic apparatus pertaining to determining an orientation of a user's finger relative to the display.

In an exemplary case, the electronic apparatus is a mobile computing and communication device such as, for example, a mobile phone.

In one aspect, the mobile phone comprises a processor, a touch-sensitive display, a position sensing system and a user interface. A shortest distance between a finger and the display and the orientation of the finger related to a two dimensional display plane can be determined dynamically by the processor through analyzing data collected by the position sensing system. A plurality of items is displayed on the display through the user interface. The displayed items may be user selectable icons. The displayed items may be organized in a hierarchical manner.

If the measured shortest distance is less than a predetermined value, the processor of the mobile device selects a subgroup of displayed items to which the finger is pointed and redisplays selected items with larger sizes through the user interface.

In one implementation, at least one of the enlarged displayed items is redisplayed with a part of contents from next hierarchical level.

In another aspect, either one finger or two fingers may be used. The user interface will not respond to the contactless movement of the finger if one finger is used. The system will respond to the contactless movement of the fingers if two fingers are used.

In one embodiment, the position sensing system comprises image sensors installed in selected positions of the mobile device. In one implementation, at least some of the image sensors are disposed beneath the display. The image sensors may also include infrared sensors.

In another embodiment, the position sensing system comprises ultrasonic sensors installed in selected positions of the mobile device including positions beneath the display.

In yet another embodiment, the position sensing system comprises temperature sensors installed in selected positions of the mobile device. In one implementation, substrate units including the temperature sensors are disposed beneath the display. Heat generated from mobile device will elevate the temperatures of the units to a level above an ambient temperature. The temperatures of the units depend on resistance of heat transfer above the units. A contactless movement of a finger modulates the resistance of heat transfer in a zone associated with the display. Local temperature of a subgroup of the units starts to increase when the finger is moving towards the subgroup of the units.

In another implementation, each of the units further includes a heating element integrated with the temperature sensor in the same substrate. The heating element brings the temperature of the unit to a predetermined level above the ambient temperature through a thermal feedback loop. A power required to sustain the predetermined temperature is measured. The power is related to the resistance of heat transfer. A finger above the unit increases the resistance and results in less power to sustain the predetermined temperature.

In another aspect of the present invention, a display can be configured as a three-dimensional (3D) touch-sensitive display with an array of temperature sensors and heating elements. The 3D touch-sensitive display not only senses a touching event but also senses contactless movement of the finger towards the display. The 3D touch-sensitive display comprises a display layer and a thermal resistance measurement layer. The thermal resistance measurement layer is disposed beneath the display layer. The thermal resistance measurement layer further comprises a plurality of thermally isolated units. Each of the units includes a heating element, a temperature sensor and thermal feedback loop, which sustains the temperature of the unit to a predetermined level above the ambient temperature. The power required to sustain the predetermined temperature level is a measurement of the resistance of heat transfer, which is further related to the contactless movement of the finger. The processor monitors power required from each of the units and determines position and orientation of the finger. The present inventive concept can be readily extended to multiple touches by multiple fingers.

### BRIEF DESCRIPTION OF THE DRAWINGS

For a more complete understanding of the present invention and its various embodiments, and the advantages thereof, reference is now made to the following description taken in conjunction with the accompanying drawings, in which:

FIG. 1A is a schematic diagram of an exemplary operation of user interface in response to changing of positions of a user's finger in accordance with a first embodiment;

FIG. 1B is a schematic functional block diagram of an exemplary mobile device;

FIG. 2 is a flowchart illustrating an exemplary operation of user interface in response to changing of positions of a user's finger in accordance with the first embodiment;

FIG. 3 is a schematic diagram of an exemplary operation of user interface in response to changing of positions of a user's finger in accordance with a second embodiment;

FIG. 4 is a flowchart illustrating an exemplary operation of user interface in response to changing of positions of a user's finger in accordance with the second embodiment;

FIGS. 5A-B is a schematic diagram of an exemplary operation of user interface in response to changing of positions of a user's finger in accordance with a third embodiment;

FIG. 6 is a flowchart illustrating an exemplary operation of user interface in response to changing of positions of a user's finger in accordance with the third embodiment;

FIG. 7 is a flowchart illustrating an aspect of the user interface for all three embodiments;

FIG. 8 is a schematic diagram of an exemplary position sensing system in accordance with a first embodiment, wherein image sensors are installed along a frame of the display;

FIG. 9 is a schematic diagram of an exemplary position sensing system in accordance with the first embodiment, wherein image sensors are disposed beneath the display;

FIG. 10 is a schematic diagram of an exemplary position sensing system in accordance with a second embodiment, wherein ultrasonic sensors are installed along a frame of the display;

FIG. 11 is a schematic diagram of an exemplary position sensing system in accordance with the second embodiment, wherein ultrasonic sensors are disposed beneath the display;

FIG. 12 is a schematic diagram of an exemplary position sensing system in accordance with a third embodiment, wherein a two dimensional temperature sensor array is disposed beneath the display;

FIG. 13 is a flowchart illustrating an exemplary operation of the position sensing system in accordance with the third embodiment;

FIG. 14 is a schematic diagram of an exemplary position sensing system in accordance with a forth embodiment, wherein a two dimensional temperature sensor array and a plurality of heating elements are disposed beneath the display;

FIG. 15 is a schematic diagram of an exemplary thermal feedback loop pertaining to controlling temperature of a substrate unit to oscillate around a predetermined value;

FIG. 16 is a flowchart illustrating an exemplary operation of the position sensing system in accordance with the forth embodiment;

FIG. 17 is a schematic diagram of an exemplary thermal feedback loop.

### DETAILED DESCRIPTION

One or more specific embodiments of the present invention will be described below. These described embodiments are only exemplary of the present invention. Additionally, in an effort to provide a concise description of these exemplary embodiments, all features of an actual implementation may not be described in the specification. It should be appreciated that in the development of any such actual implementation, as in any engineering or design project, numerous implementation-specific decisions must be made to achieve the developers' specific goals, such as compliance with system-related and business related constraints, which may vary from one implementation to another. Moreover, it should be appreciated that such a development effort might be complex and time consuming, but would nevertheless be a routine undertaking of design, fabrication, and manufacture for those of ordinary skill having the benefits of this disclosure.

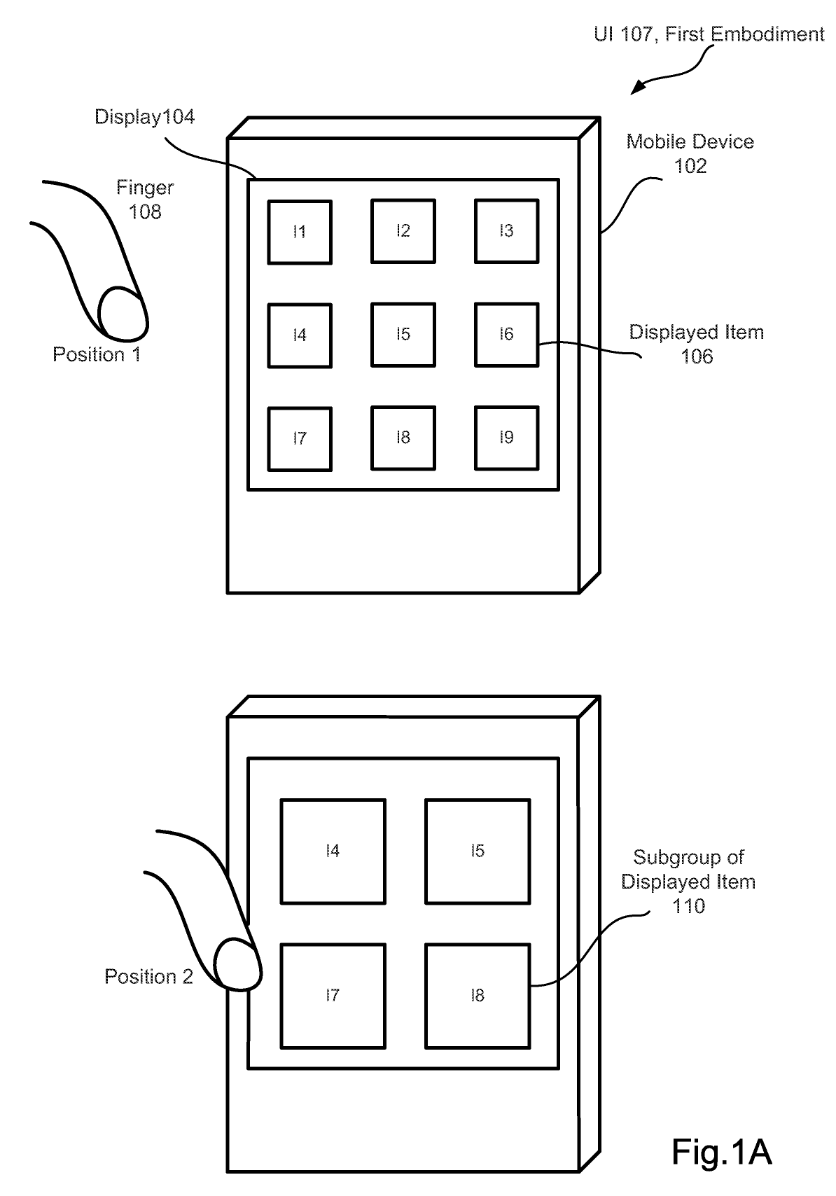

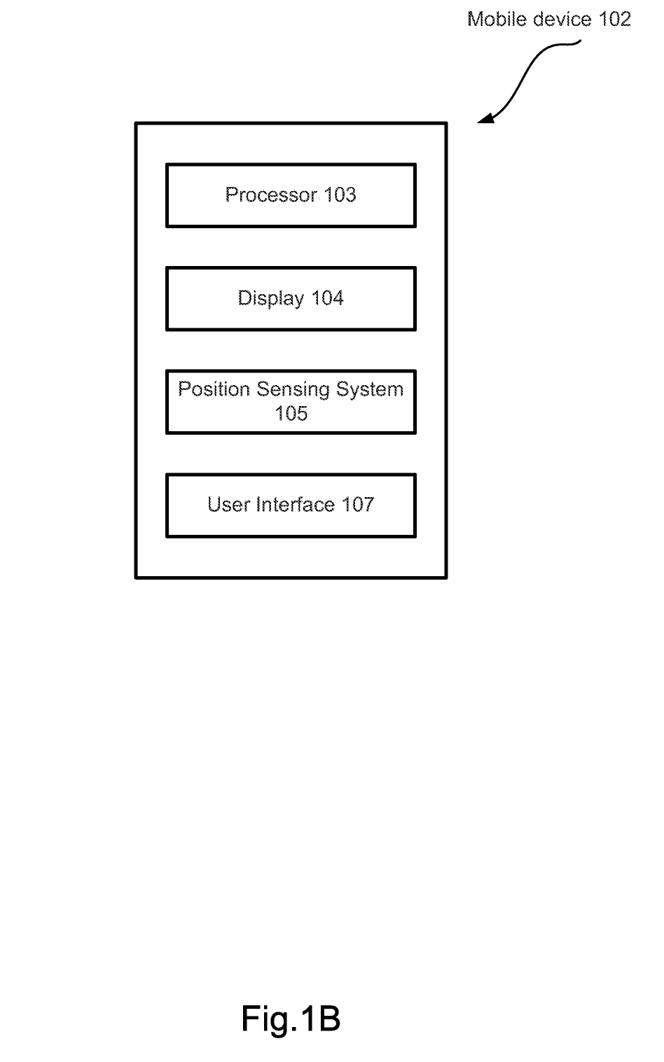

FIG. 1A is a schematic diagram of an exemplary operation of user interface in accordance with a first embodiment. Mobile computing and communication device 102 is used exemplarily to illustrate present inventive concept. The present inventive concept can be applied to any electronic apparatus with a display. Mobile device 102 includes but is not limited to a smart phone, a tablet computer, a laptop computer, a handheld media player, a wearable computing and communication device and a game console. As shown in FIG. 1B, mobile device 102 includes processor 103, display 104, position sensing system 105 and user interface 107. Display 104 is a touch-sensitive display in an exemplary case. The present inventive concept is not limited to the touch-sensitive display. A plurality of displayed items 106 are displayed on display 104 through user interface 107. For example, a plurality of user selectable icons 11-9 is displayed. A schematic illustration of finger 108 of a user is illustrated exemplarily in FIG. 1A. The present inventive concept can be extended to any object such as, for example, a stylus.

Position sensing system 105 detects a contactless movement of finger 108. A shortest distance between finger 108 and display 104 can be determined by processor 103 through analyzing data collected by position sensing system 105. Processor 103 can further determine orientation of finger 108 through analyzing the data collected by position sensing system 105.

As shown in FIG. 1A, finger 108 in position 1 does not affect the displayed items when the shortest distance between finger 108 and display 104 is more than a predetermined threshold value. In an exemplary case, the predetermined value can be any value in a range of 1 mm to 20 mm. After finger 108 is moved to position 2, the shortest distance is less than the threshold value. In response to the contactless movement of finger 108, user interface 107 executed by processor 103 redisplays a subgroup of displayed items 110 with larger size. Position sensing system 105 not only detects the shortest distance between finger 108 and the display 104, but also determines the orientation of the finger. The subgroup of the displayed items 110 is selected based upon the orientation of finger 108.

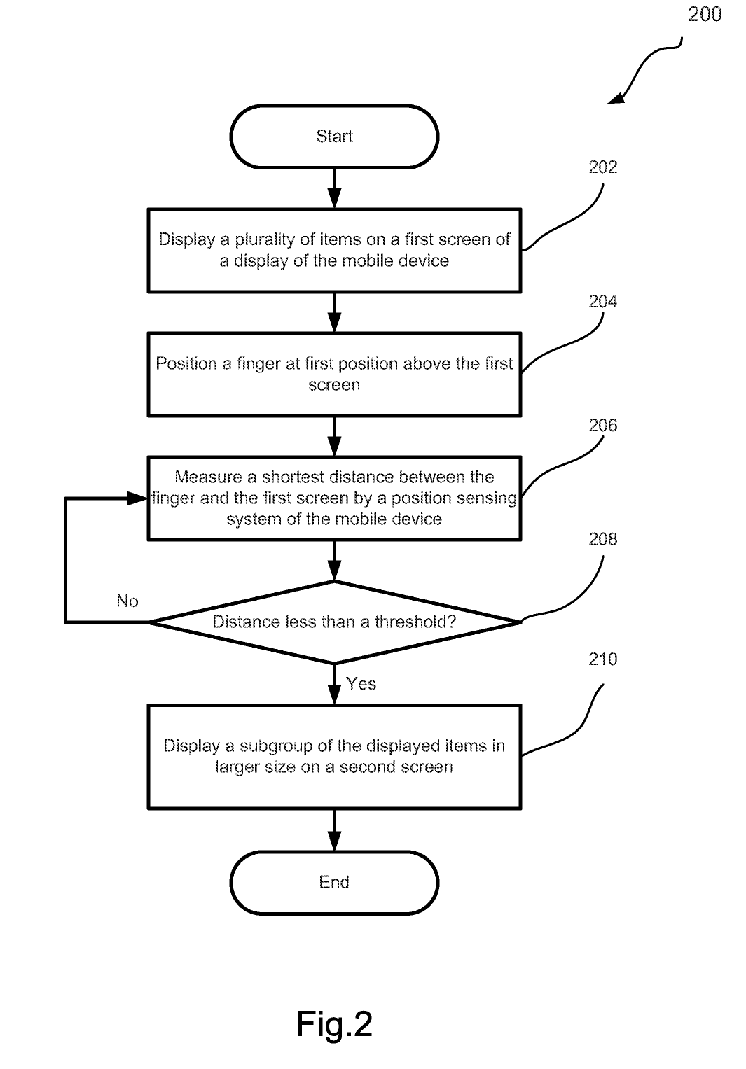

FIG. 2 is a flowchart illustrating an exemplary operation of user interface in accordance with the first embodiment. Process 200 starts with step 202 that a plurality of items (106) is displayed on a first screen of display 104 of mobile device 102. Displayed items 106 may be user selectable items. Displayed items may be icons displayed on a touch-sensitive display. Displayed items may include sub items and be organized in a hierarchical structure. If one of the displayed items 106 is selected by a user through a user input device of mobile device 102, a plurality of sub items may be displayed in a new display screen. A hierarchical user interface may include multiple levels. Finger 108 is positioned at a first position above the first screen in step 204. The shortest distance between finger 108 and display 104 is determined by processor 103 through position sensing system 105 in step 206. Position sensing system 105 determines both the shortest distance and the orientation of finger 108. In step 208, processor 103 decides if the distance is less than the threshold value. If the decision is positive, processor 103 selects a subgroup 110 of displayed items 106 and redisplays the items from subgroup 110 with the larger size in step 210 through user interface 107.

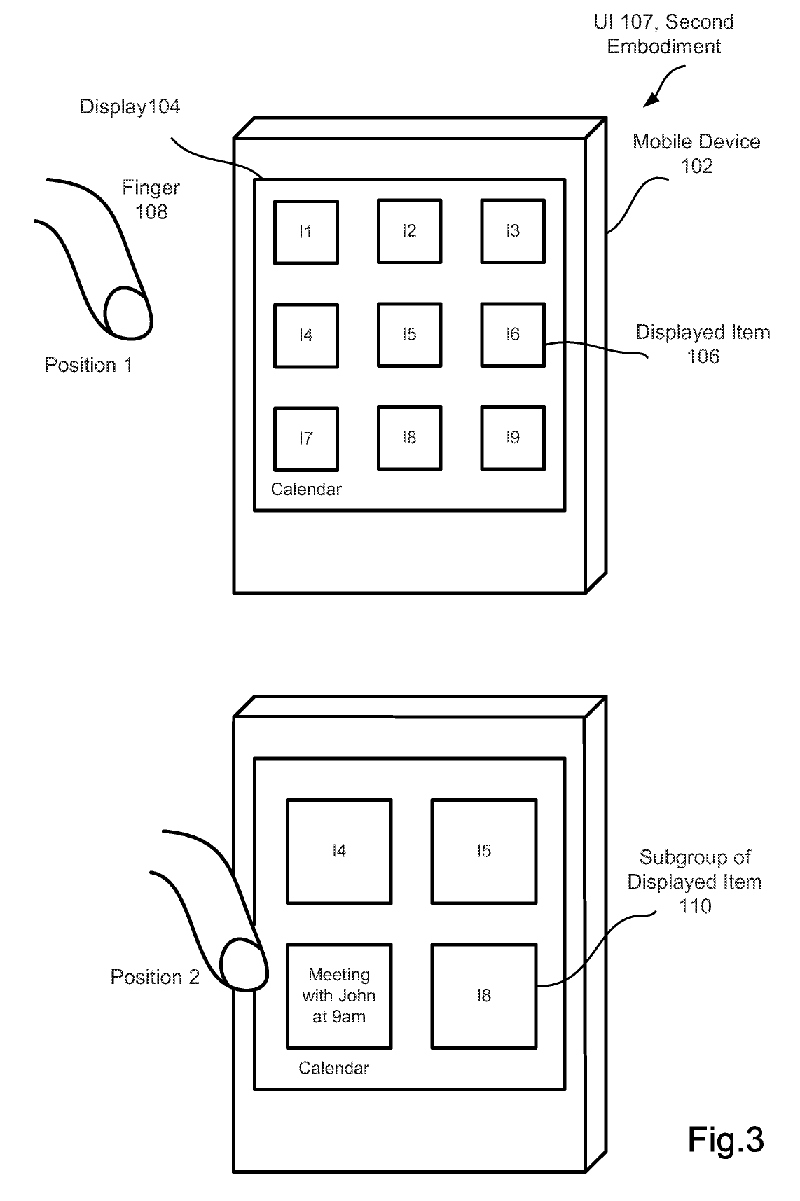

FIG. 3 is a schematic illustration of the operation of user interface 107 in accordance with the second embodiment. The second embodiment is identical to the first one except that a part of contents in second hierarchical level is displayed in accompanying with redisplaying of at least one of the displayed items in subgroup 110. In an exemplary illustration, an icon for calendar is redisplayed with a larger size after the processor determines that finger 108 is moving towards and is pointing approximately to the icon. The redisplayed icon includes an item in the calendar. In another exemplary case, an email icon may be redisplayed with a larger size including a few latest email titles. In yet another exemplary case, a weather forecast icon may be redisplayed with a larger size including a weather forecast for the current position of the mobile device.

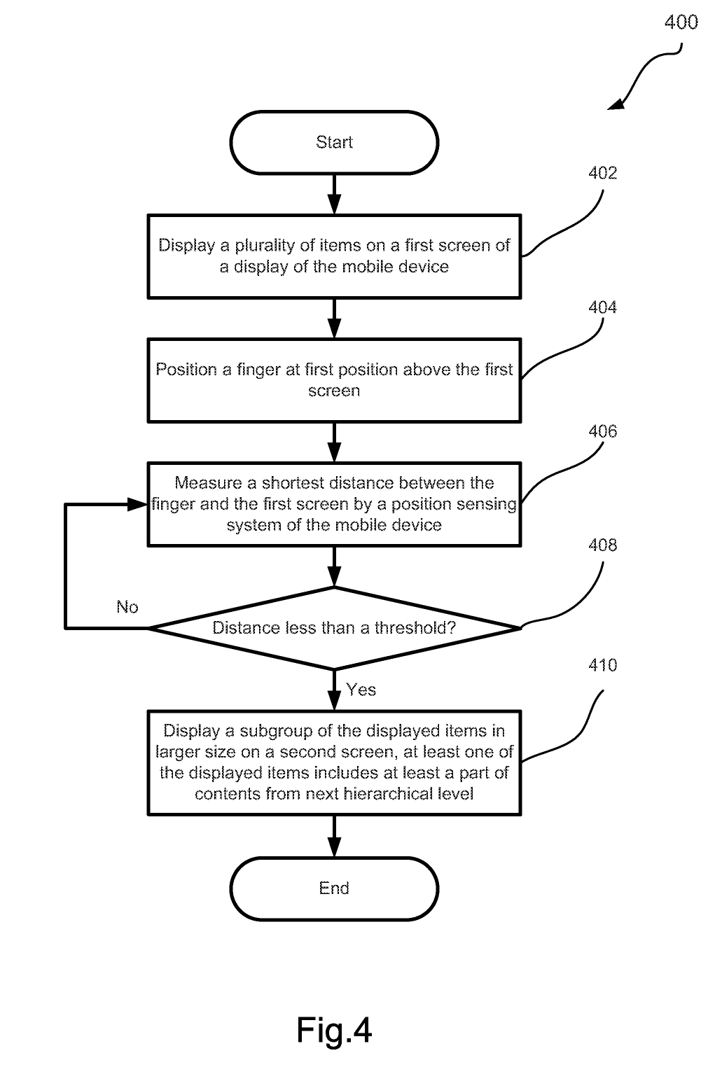

FIG. 4 is a flowchart illustrating an exemplary operation of user interface 107 in accordance with the second embodiment. The flowchart is similar to the flowchart for the first embodiment except that at least one of the redisplayed items in larger size includes at least a part of contents in the next hierarchical level in step 410.

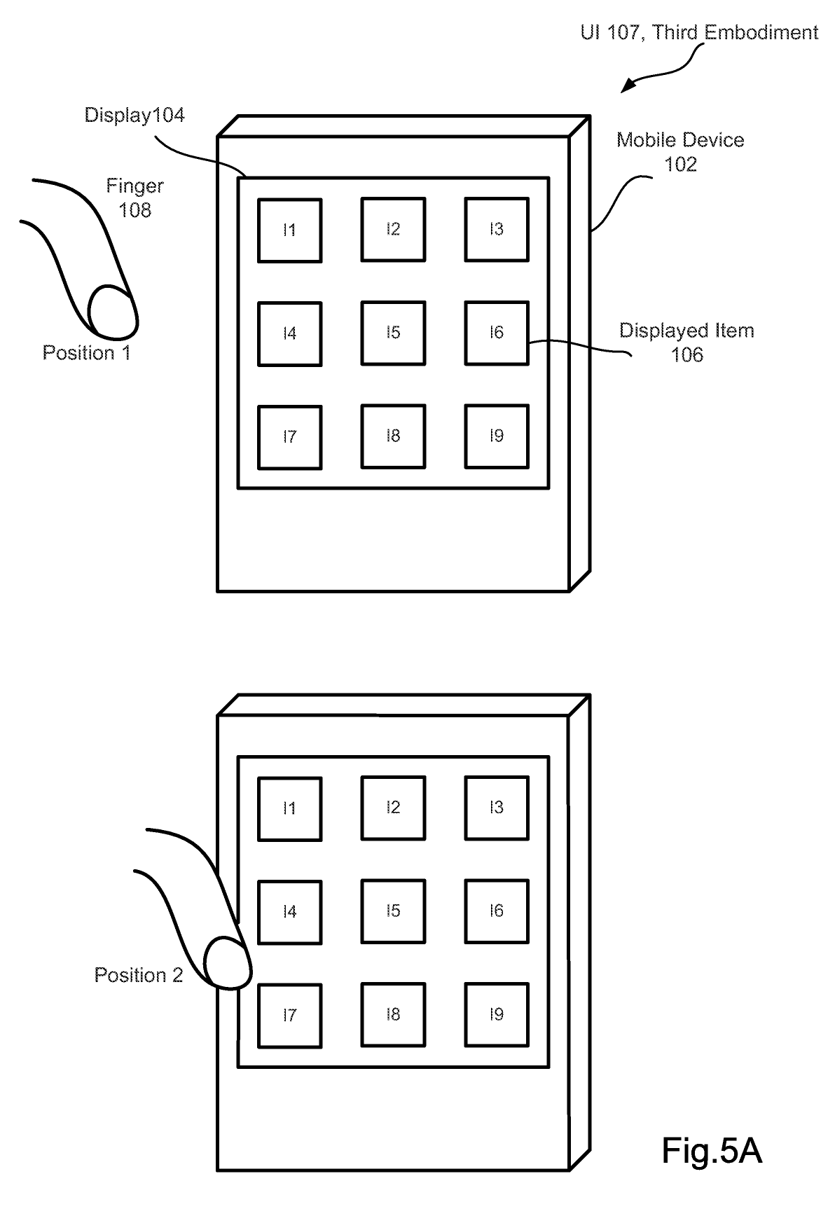

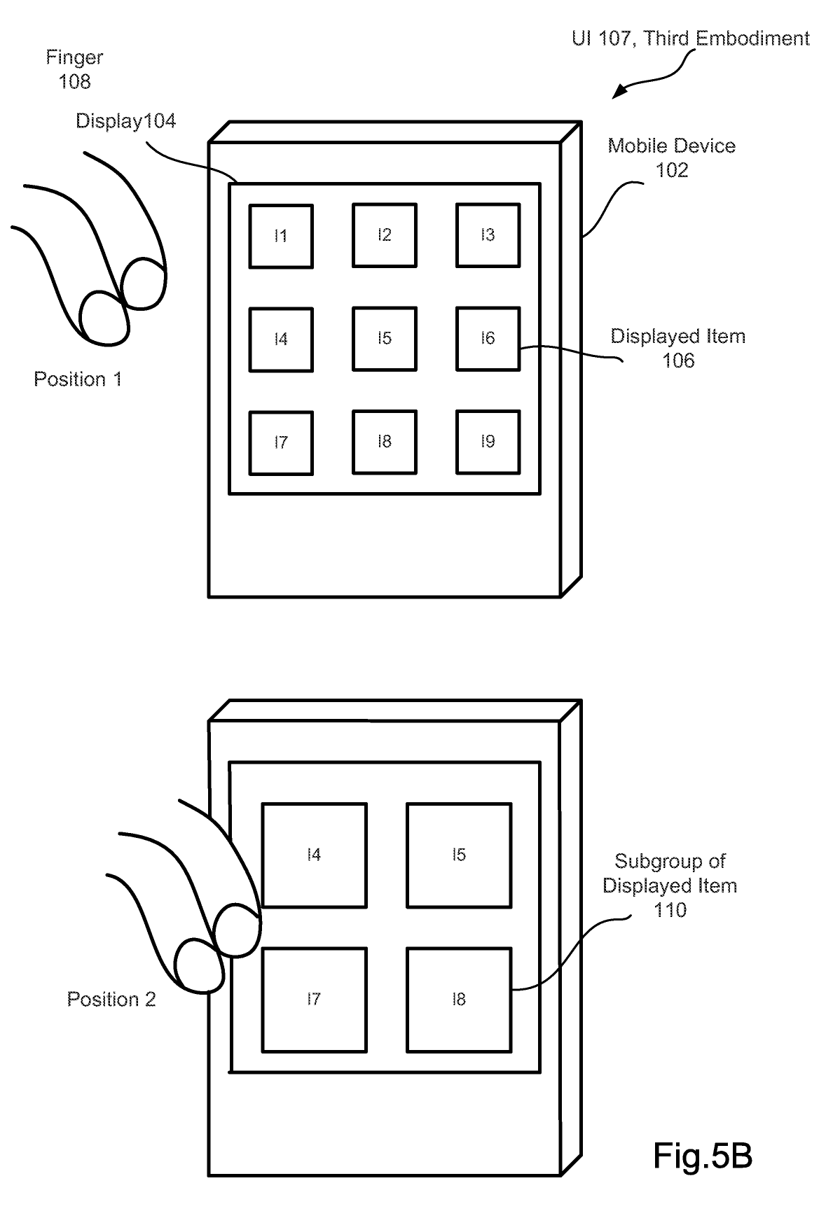

FIGS. 5A-B is a schematic diagram of user interface 107 in accordance with a third embodiment. User interface 107 in the third embodiment provides flexibility for a user to select or not to select a function of enlarging a subgroup of displayed item 110 when the user's finger is approaching the items. In FIG. 5A, user interface 107 does not respond to the contactless movement of finger 108 if only one finger is positioned. In FIG. 5B, user interface 107 responds to the contactless movement of finger 108 and redisplays the subgroup of displayed items 110 with larger sizes if two fingers are positioned.

In yet another embodiment, the subgroup of displayed items 110 is redisplayed with larger sizes if two fingers are presented, wherein at least one item from the subgroup is redisplayed with a part of contents from the next hierarchical level.

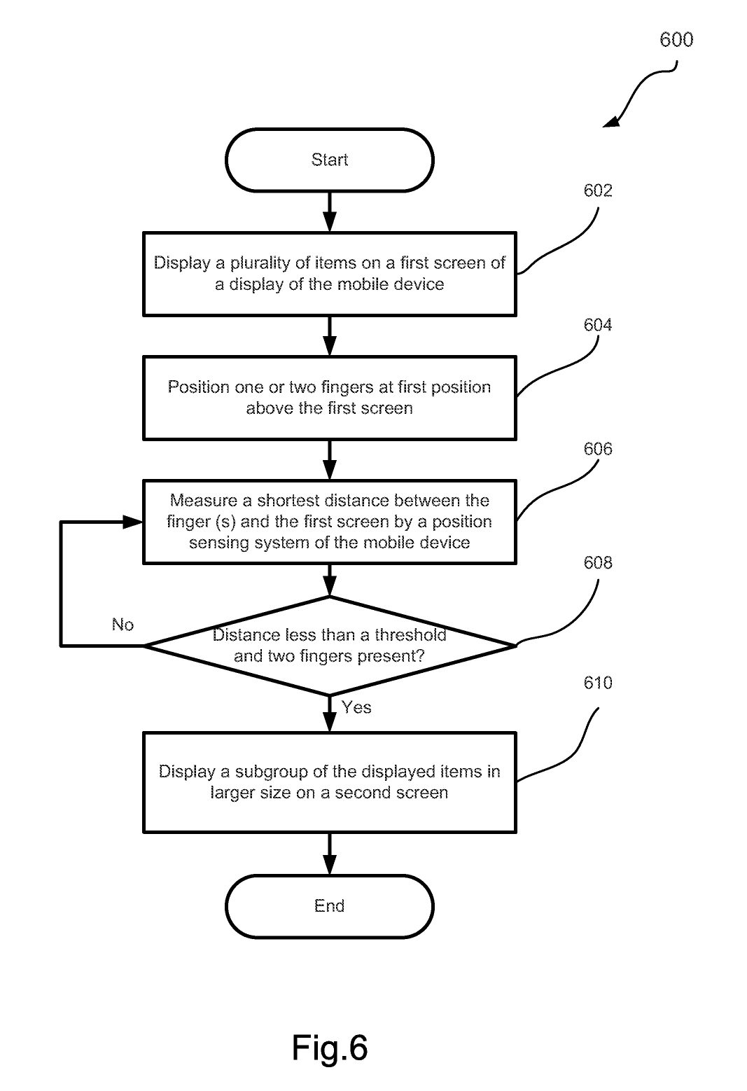

FIG. 6 is a flowchart illustrating an exemplary operation of user interface 107 in accordance with the third embodiment. Process 600 starts with step 602 that a plurality of items (106) is displayed on a first screen of display 104 of mobile device 102. One or two fingers 108 are positioned at a first position above the first screen in step 604. The shortest distance between finger(s) 108 and display 104 is determined by processor 103 through position sensing system 105 in step 606. Processor 103 determines both the shortest distance and the orientation of finger 108 based on the data collected by position sensing system 105. According to the third embodiment, position sensing system 105 further determines if one or two fingers are presented. In step 608, processor 103 decides if the shortest distance between finger 108 and display 104 is less than the threshold value and also decides if one or two fingers are positioned. If the decision is positive, processor 103 selects a subgroup 110 of displayed item 106 and redisplays the subgroup items with the larger size in step 610 through user interface 107.

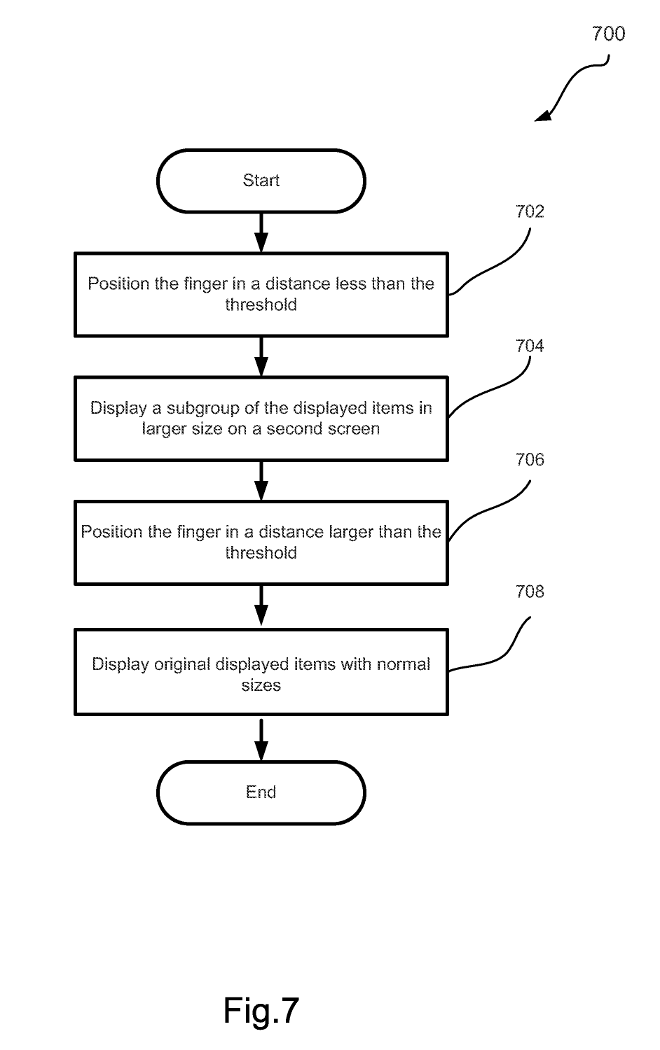

FIG. 7 is a flowchart illustrating one aspect of user interface 107 for all of the three embodiments. Process 700 starts with step 702 that finger 108 is positioned in a distance less than the threshold value. The subgroup of displayed items 110 is redisplayed in step 704 with larger sizes. Subsequently, the user moves finger 108 away to have the shortest distance more than the threshold value in step 706. In response to the contactless movement of finger 108, displayed items 106 are redisplayed with normal sizes in step 708.

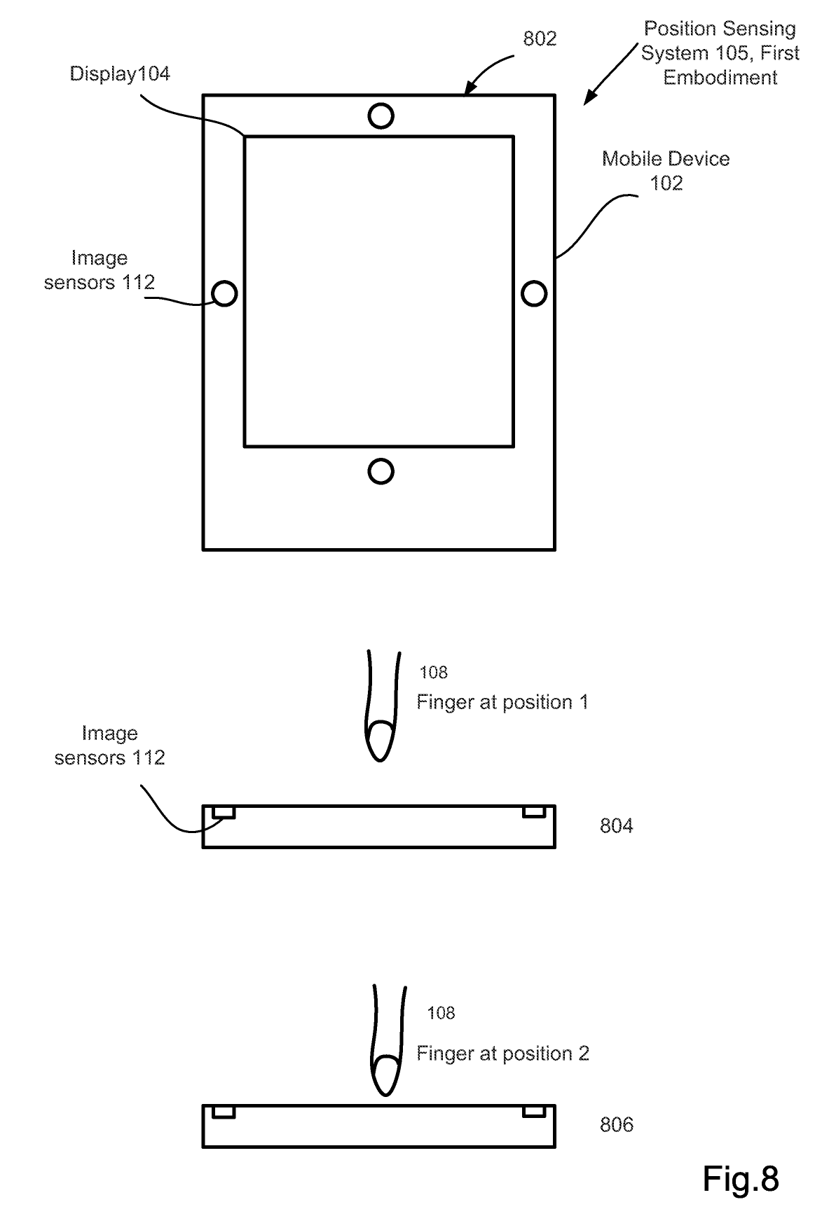

FIG. 8 is a schematic diagram of an exemplary position sensing system 105 in accordance with a first embodiment. Mobile device 102 includes a house, a front surface and a back surface. In one aspect as shown in 802, mobile device 102 includes a display 104 in a rectangular shape on the front surface in an exemplary case. Image sensors 112 are disposed in selected positions of the front surface along a frame of display 104. Image sensors 112 may be sensors for visible lights. Image sensor 112 may also be sensors for invisible lights such as, for example, for infrared radiations. Image sensors 112 may even be a combination of sensors for measuring both visible lights and the infrared radiations. In one implementation, each of four image sensors is disposed approximately at a middle point of each of the sides of the rectangular display. Each of the sensors 112 takes photos of the finger 108 from different angles when the finger is approaching display 104 as shown in 804 and 806. The photos are transmitted to processor 103 for analyzing. Processor 103 determines the shortest distance between finger 108 and display 104 through analyzing data collected by image sensors 112. Processor 103 further determines orientation of finger 108 based on the data. A control signal is generated when the distance between finger 108 and display 104 is less than the threshold value. The control signal can be used to redisplay a subgroup of displayed items with larger size through user interface 107.

More or less image sensors may be disposed at different positions in the front surface of mobile device 102.

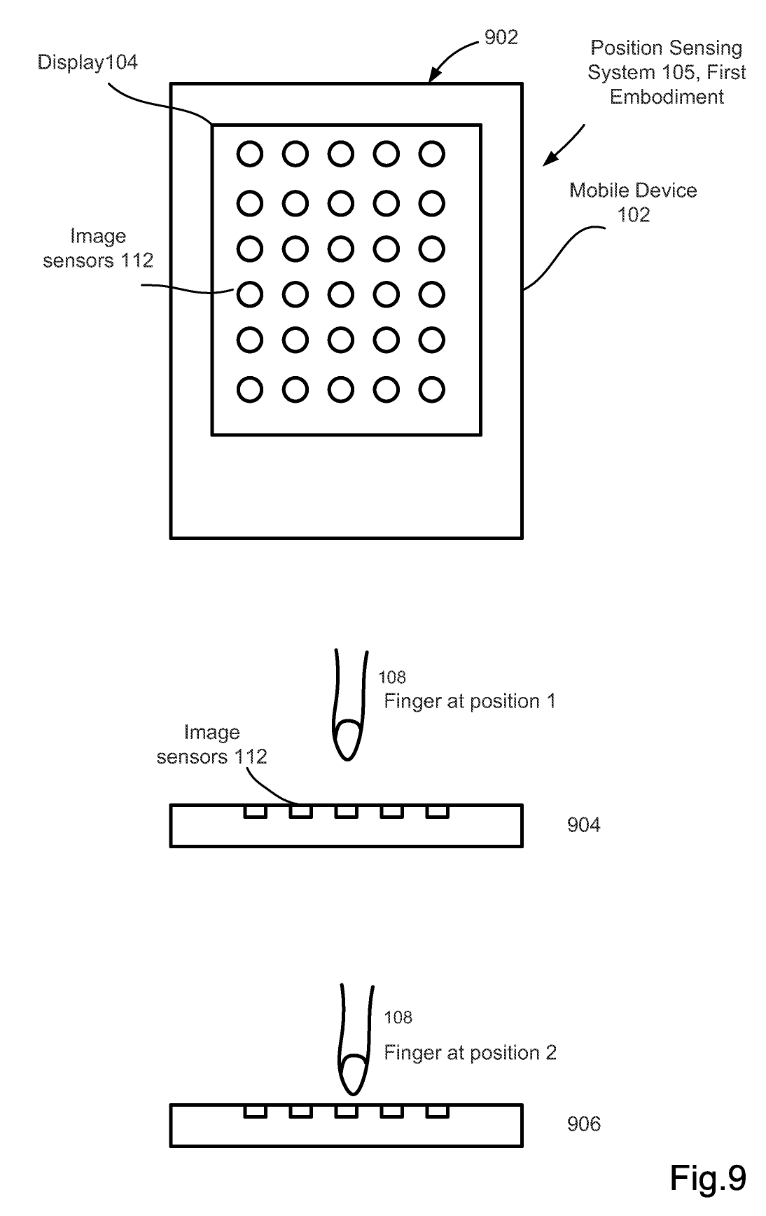

In another aspect of the first embodiment of position sensing system 105 as shown in FIG. 9, image sensors are disposed underneath display 104. In an exemplary case, the image sensors are configured as a two dimensional array.

In yet another aspect, image sensors 112 may be disposed beneath display 104 and also in the positions outside the display area.

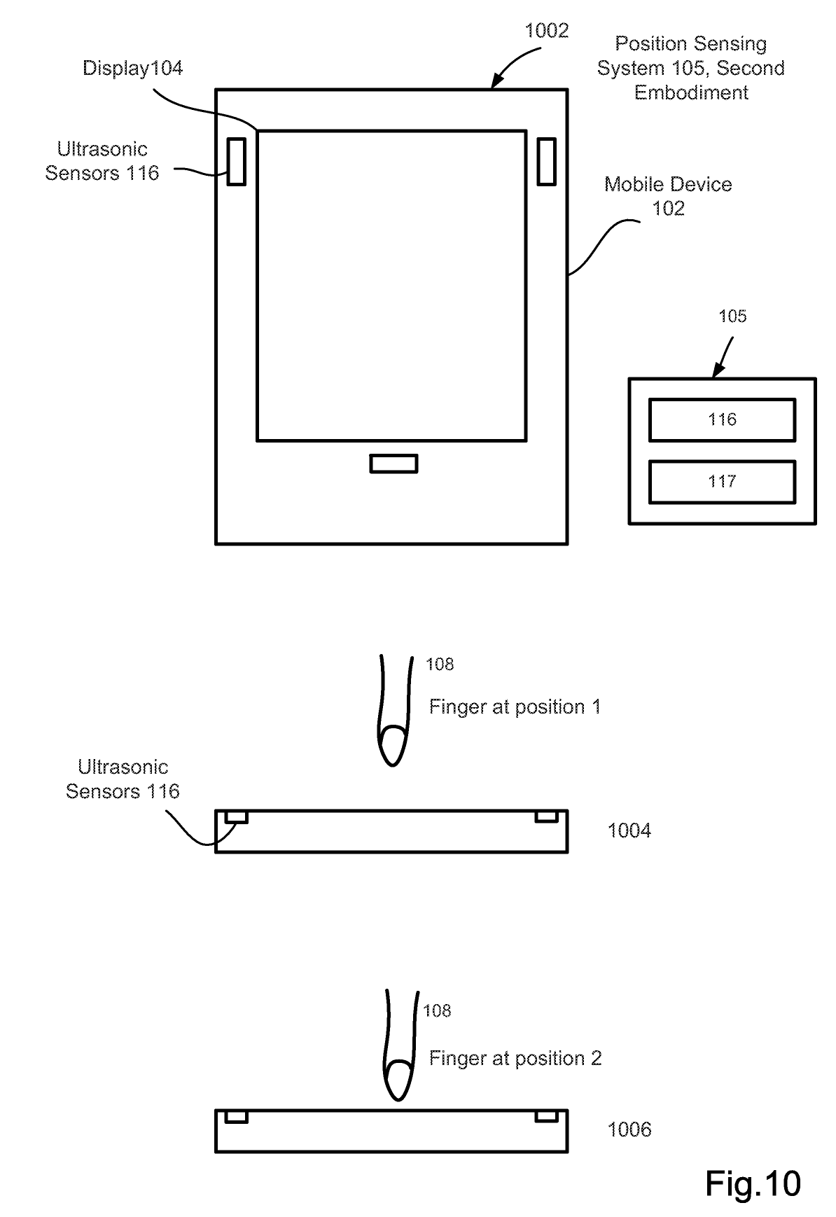

FIG. 10 is a schematic diagram of an exemplary position sensing system 105 in accordance with a second embodiment. In one implementation as shown in 1002, a plurality of ultrasonic sensors 114 are disposed in selected positions outside the display area. In one aspect, three sensors are installed as shown in FIG. 10 in an exemplary manner. The ultrasonic sensor 114 further comprises a sound generating unit 116 and a sound receiving unit 117. Ultrasonic sensors 116 generate high frequency sound wave through sound generating units 116 and receive the sound wave reflected from finger 108 by sound receiving units 117. Received signals are analyzed by processor 103. The position and orientation of finger 108 can be determined by performing a triangulation by the processor. When a user moves finger 108 as shown in 1002 and 1006, a three dimensional image can be reconstructed by processor 103 based upon received sound signals. A control signal is generated if the distance between finger 108 and display 104 is less than the threshold value. More than three ultrasonic sensors may be used to improve accuracy of the measurement.

In another implementation, sound generating unit 116 and sound receiving unit 117 may be disposed in different locations. Sound receiving units may also be used as conventional microphones for mobile device 102.

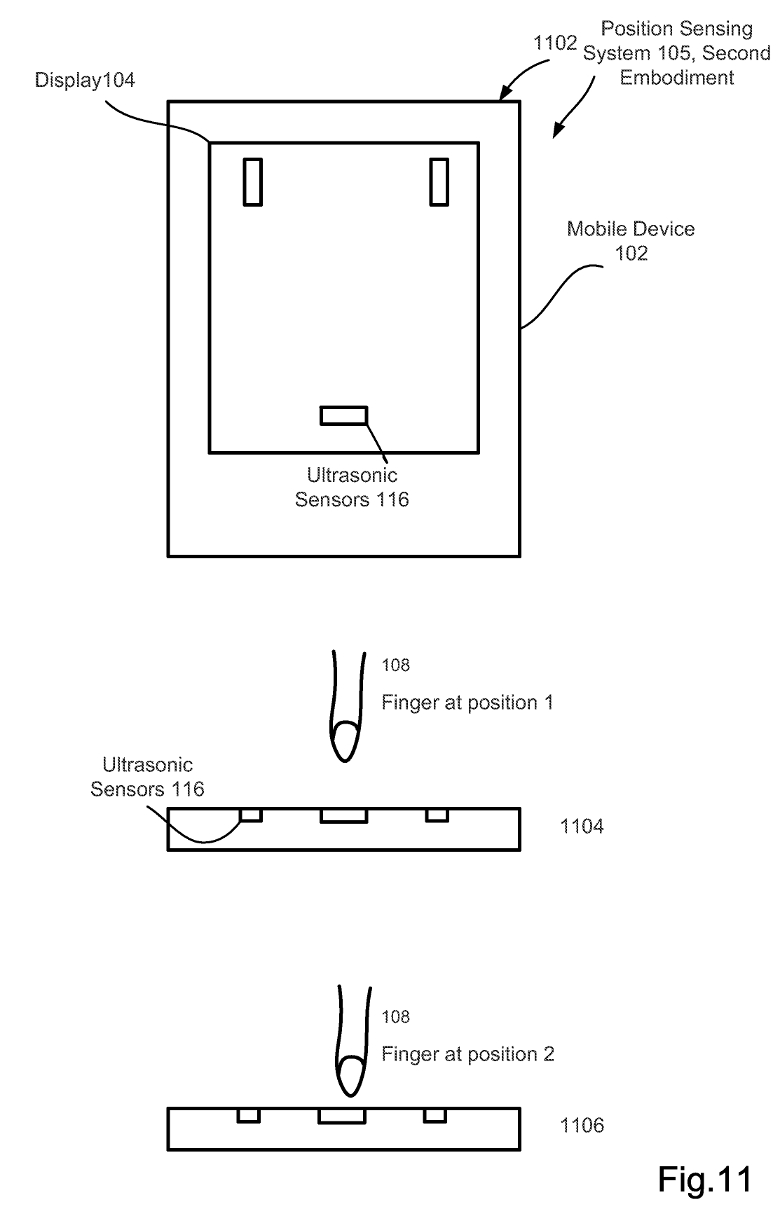

FIG. 11 is a schematic diagram of an exemplary position sensing system 105 in accordance with another implementation of the second embodiment, wherein ultrasonic sensors 116 are disposed beneath display 104 as shown in 1102. The contactless movement of finger 108 as shown in 1104 and 1106 can be tracked by processor 103 through position sensing system 105. A control signal is generated if the distance between finger 108 and display 104 is less than the threshold value. Three ultrasonic sensors are depicted in FIG. 11. More or less ultrasonic sensors may be used. Ultrasonic sensors may be arranged in a two-dimensional array. Ultrasonic sensors can also be disposed beneath display 104 and also be disposed outside the display area in the front surface of mobile device 102.

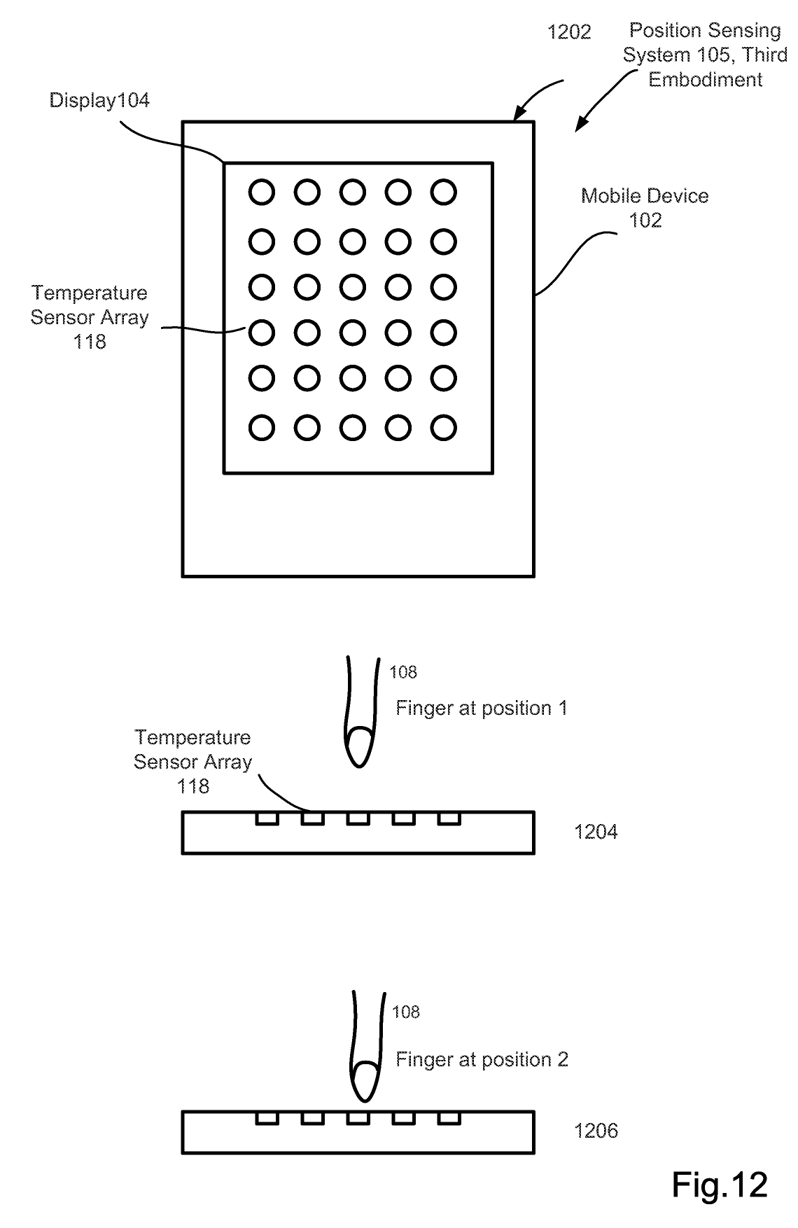

FIG. 12 is a schematic diagram of an exemplary position sensing system 105 in accordance with a third embodiment. An array of temperature sensor 118 as shown exemplarily in 1202 is disposed beneath display 102. Temperature sensors 118 measures temperature distribution or map in a plane beneath display 104. Each of temperature sensors is disposed in a substrate unit. The substrate units are disposed underneath display 104. The operations of mobile device 102 generate heat, which is called self heating in this disclosure. The temperature sensors measure the temperature of each of the substrate units. The measured temperatures form a temperature map overlapping the display plane. The temperature map is measured according to a predetermined frequency and is transmitted to processor 103 in real time base. The self heating leads to the measured temperatures at levels higher than an ambient temperature. The heat is transferred to the ambient through display 104. Each of the substrate units is associated with a resistance of heat transfer. The resistance is affected by an object in the heat transfer path and also by the distance of the object to the substrate unit. If the path of the heat transfer is blocked by finger 108, temperatures measured in a zone underneath finger 108 are higher than the temperature measured in a zone without finger 108 above it. As shown in 1204 and 1206, moving finger 108 from position 1 to position 2 creates a temperature map having a zone beneath finger 108 with higher temperatures.

In one implementation, a two dimensional temperature sensor array 118 is placed in a substrate in a form of a sheet which can be placed beneath the display plane. Each of the sensors can be accessed by the processor through an address decoder and a bit line and a word line. The temperature sensors may be silicon based sensors manufactured by a semiconductor manufacturing process. The temperature sensors may also be thin film based sensors manufactured by a thin film process. The word and the bit lines can also be formed by the thin film process.

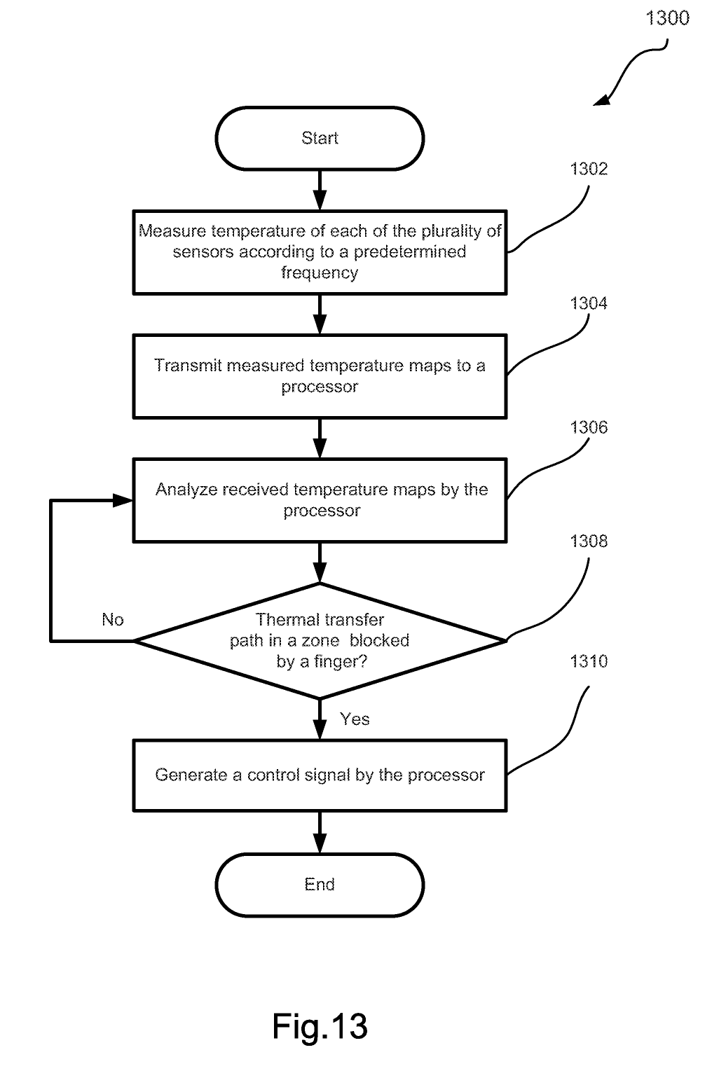

FIG. 13 is a flowchart illustrating an exemplary operation of position sensing system 105 in accordance with the third embodiment. Process 1300 starts with step 1302 that the temperature map of a plane beneath display 104 is determined by temperature sensors in array 118 in accordance with a predetermined frequency. Measured temperature maps are transmitted to processor 103 in step 1304. The received temperature maps are analyzed by processor 103 in step 1306. Processor 103 decides in step 1308 if the heat transfer paths are blocked by finger 108 that leads to increasing in temperatures in a zone of substrate beneath finger 108. If the result is positive, a control signal is generated by processor 103 in step 1310. Otherwise, processor 103 will continue to analyze received temperature maps until an event of blocking the heat transfer path by finger 108 is detected.

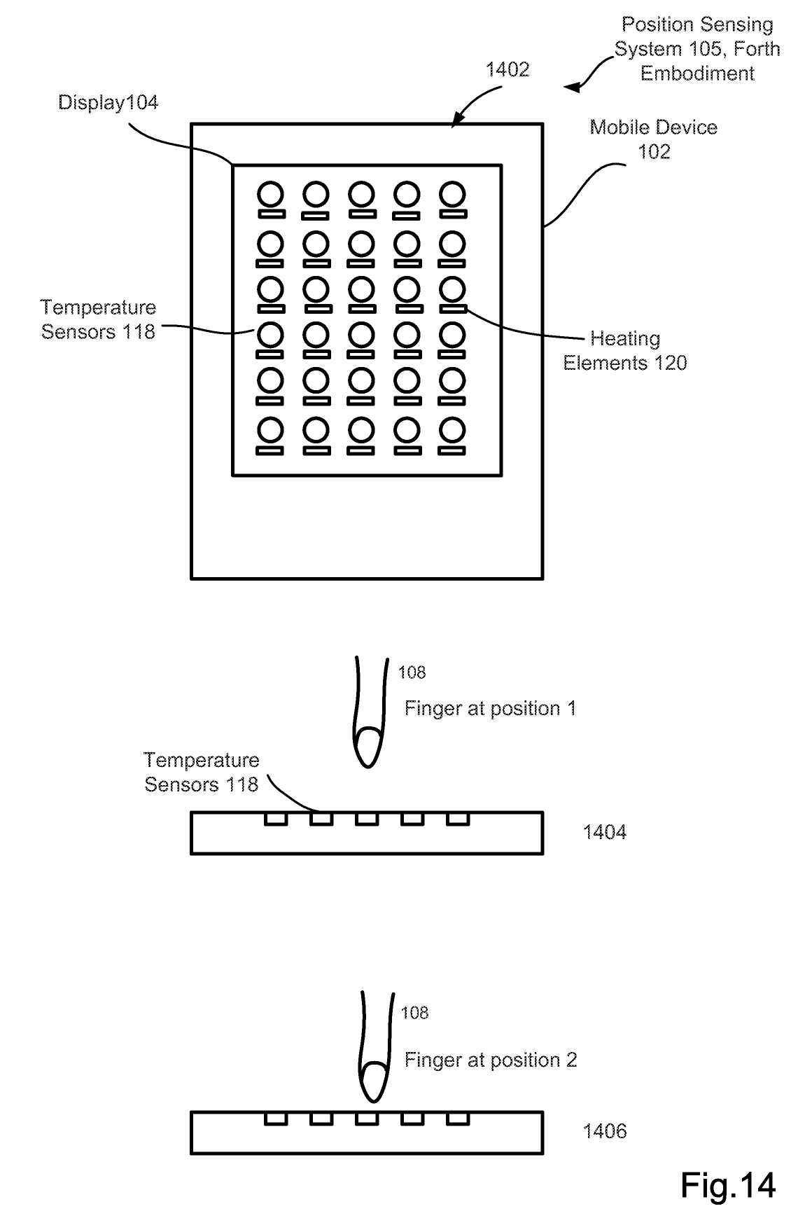

FIG. 14 is a schematic diagram of an exemplary position sensing system 105 in accordance with a forth embodiment. In one aspect as shown in 1402, a substrate sheet is disposed beneath display 104. The substrate sheet includes a plurality of units. Each of the units includes one of temperature sensors 118 and one of heating elements 120. In one implementation, the heating element is placed next to the temperature sensor in each of the units. In another implementation, the heating element and the temperature sensor can be integrated in a single substrate unit. The substrate unit may be a chip. The heating element 120 and the temperature sensor 118 can be disposed in a microstructure of the chip manufactured by a micromachining technology. Heating elements 120 include but are not limited to heating resistors and heating transistors. Each of the substrate units is thermally isolated. The temperature sensors 118 and the heating elements 120 can be connected to processor 103 through a bit/word line structure.

In accordance with the forth embodiment, each of the heating elements 120 sets the temperature measured by each of the temperature sensors 118 to a predetermined value above the ambient temperature. Power for each of the heating elements required to sustain the predetermined value is measured and is transmitted to processor 103. Heat is transferred to the ambient through display 104. If the heat transfer in a zone associated with a zone in the display plane is blocked by an object such as, for example, finger 108, the power required to sustain the predetermined value is reduced. By measuring power required to sustain the predetermined temperature, the object moving from position 1 in 1404 to position 2 in 1406 can be detected. Thermal feedback loops can be used to control the temperature of each unit to oscillate around the predetermined value within a small range.

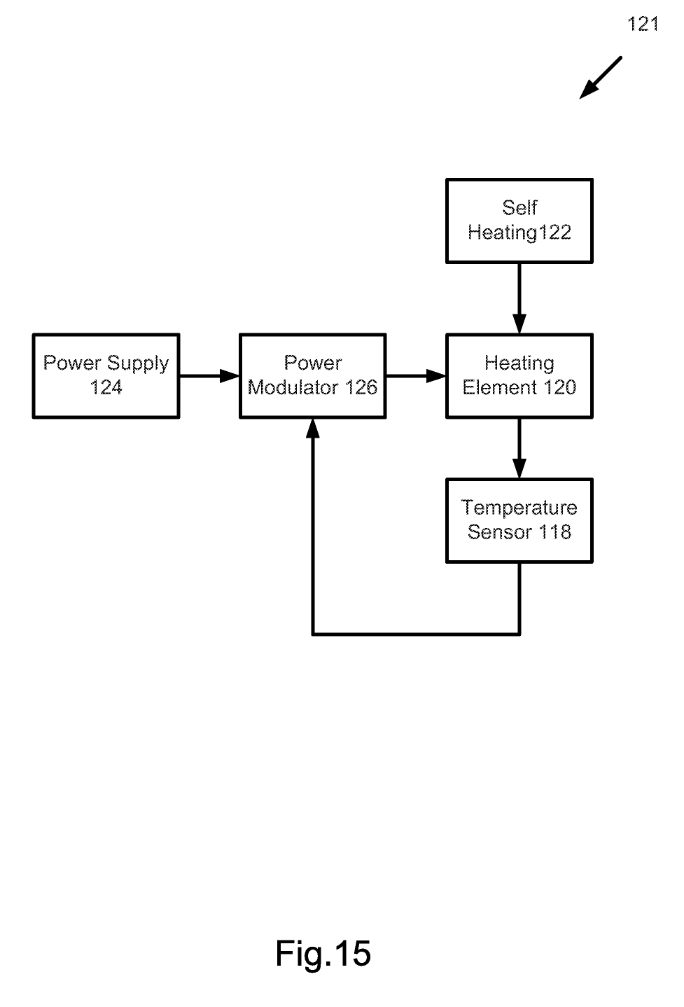

FIG. 15 is a schematic diagram of an exemplary thermal feedback loop 121 pertaining to controlling temperature of a substrate unit to oscillate around a predetermined value. Such an implementation is known from an article by Pan (the present inventor) and Huijsing in Electronic Letters 24 (1988), 542-543. This circuit is theoretically appropriate for measuring physical quantities such as resistance of thermal transfer, speed of flow, pressure, IR-radiation, or effective value of electrical voltage or current (RMS), the influence of the quantity grated integrated circuit (chip) to its environment being determined in these cases. In these measurements, a signal conversion takes place twice: from physical (resistance of thermal transfer path, speed of flow, pressure, IR-radiation or RMS value) to the thermal domain, and from the thermal to the electrical domain.

This known semiconductor circuit theoretically consists of a heating element, integrated in the circuit, and a temperature sensor. The power dissipated in the heating element is measured with the help of an integrated amplifier unit, an amplifier with a positive feedback loop being used, because of which the temperature oscillates around a constant value with small amplitude. In the known circuit the temperature will oscillate in a natural way because of the existence of a finite transfer time of the heating element and the temperature sensor with a high amplifier-factor.

As shown in FIG. 15, thermal feedback loop 121 includes temperature sensor 118 and heating element 120. Temperature sensor 118 and heating element 120 are disposed close to each other. Temperature sensor 118 and heating element 120 can also be integrated into a single substrate. The heat may also be generated from self heating 122 resulting from operations of mobile device 102. Thermal feedback loop 121 further comprises power supply 124 and power modulator 126. Power modulator 126 converts an incoming power into a desired form such as, for example, into a Pulse Width Modulation (PWM) or a bit stream form. Temperature sensor 118 measures temperature of the unit. Temperature sensor 118 is coupled to power modulator 126 that adjusts its output based upon the measured temperature. Temperature sensor 118 may be a diode or a transistor. Temperature sensor 118 may also be a resistor such as, for example, a poly-crystalline silicon resistor or a resistor formed by a diffused layer in a typical integrated circuit process.

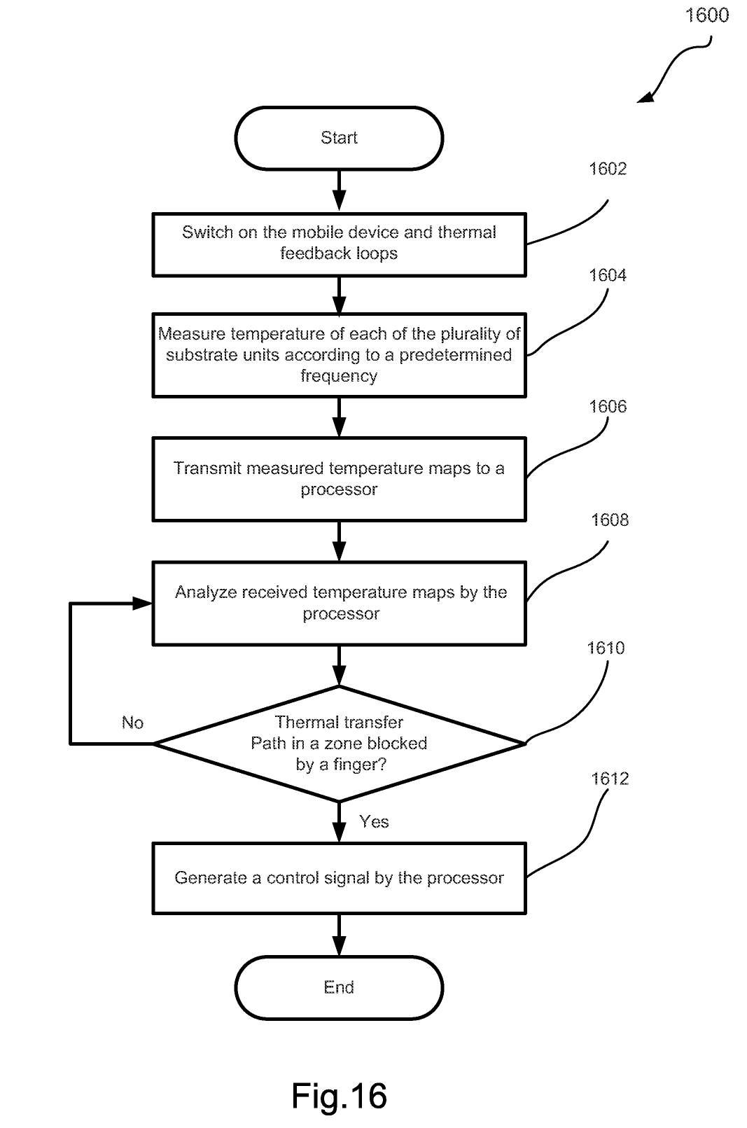

FIG. 16 is a flowchart illustrating an exemplary operation of position sensing system 105 in accordance with the forth embodiment. Process 1600 starts with step 1602 that mobile device 102 is switched on. Temperatures of all units are brought up to the predetermined level through thermal feedback loop 121 comprising temperature sensor 118 and heating element 120. The temperatures are measured according to a predetermined frequency in step 1604. Powers required to sustain the elevated temperatures are measured and are transmitted to processor 103 in step 1606. Powers required to sustain the predetermined temperature in each of the units are analyzed by processor 103 in step 1608. Processor 103 decides in step 1610 if finger 108 has been placed above a zone of display 104 to block the heat transfer path. If the result is positive, a control signal is generated by the processor in step 1612.

The present inventive concept based upon the forth embodiment of the position sensing system 105 can be generalized to provide a novel three-dimensional touch-sensitive display. The display can sense contactless movement of finger 108 in additional to sensing an event of touching of the display by finger 108.

In one aspect of the present invention, display 104 can be configured as a three-dimensional (3D) touch-sensitive display with an array of temperature sensors 118 and heating elements 120. The 3D touch-sensitive display 104 not only senses a touching event but also senses contactless movement of finger 108 towards display 104. The 3D touch-sensitive display 104 comprises a display layer and a thermal resistance measurement layer. In one implementation, the thermal resistance measurement layer is disposed beneath the display layer. The thermal resistance measurement layer further comprises a plurality of thermally isolated units. Each of the units includes one of the temperature sensors 118, one of the heating elements 120 and other components required for thermal feedback loop 121 as shown in FIG. 15. Thermal feedback loop 121 sustains the temperature of the unit to a predetermined level above the ambient temperature. The power required to sustain the predetermined temperature level is a measurement of the resistance of the heat transfer, which is further related to the contactless movement of finger 108. Processor 103 monitors power required from each of the units and determines position and orientation of finger 108. Finger 108 starts to affect a heat transfer path when the finger is within a predetermined distance of the display 104. The power required to sustain the temperatures of some of the units, therefore, starts to drop because of slower heat transferring from the units to the ambient.

In another implementation, the thermal resistance measurement layer is merged with the display layer. Temperature sensors 118, heating elements 120 and some of other components in thermal feedback loops 121 are manufactured based upon at least a part of process flows formed the display layer.

If mobile device 102 is a wearable device, the size of its display 104 is relatively small. A chip including temperature sensors 118, heating elements 120 and the other components in thermal feedback loops 121 can be disposed beneath display 104. The size of the chip is approximately equal to the size of display 104. The chip may be thinned down before attaching to the display layer. In one implementation, the chip is manufactured by an integrated circuit process flow. In one aspect, the chip may be made by a Silicon-On-Insulator (SOI) substrate to achieve thermal isolation among the units.

The system may also include an ambient temperature sensor for measuring the ambient temperature. In one implementation, the ambient temperature sensor is thermal isolated from the substrate unit and the rest of the mobile device. The measured ambient temperature is transmitted to each f the units by processor 103 to set the predetermined temperature level.

The present inventive concept can be readily extended to multiple touches by multiple fingers.

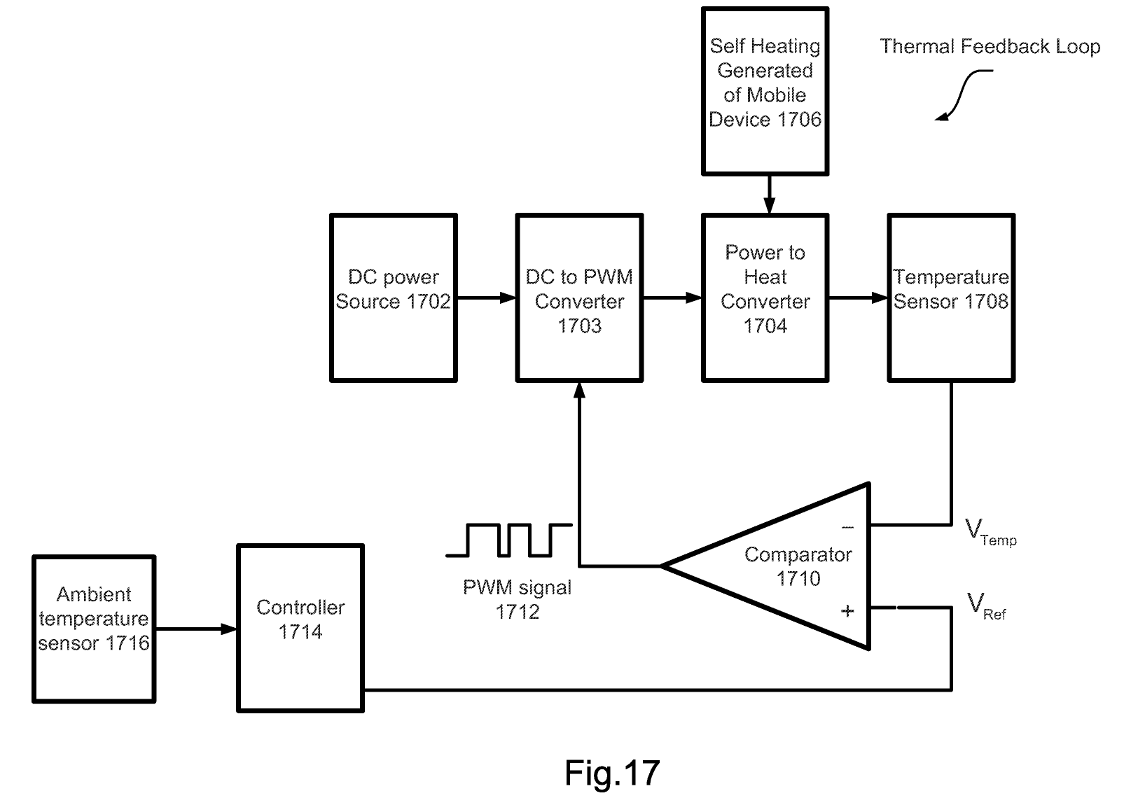

FIG. 17 shows an exemplary implementation of the thermal feedback principle as mentioned above to measure if the heat transfer path is blocked. A thermal feedback loop in accordance with one implementation includes a DC power source 1702, DC to PWM converter 1703 and power to heat converter 1704. The thermal feedback loop further comprises self heating 1706 generated from operations of mobile device 102. Power to heat converter 1704 further includes a heating element. The heating element may be a heating resistor in an exemplary case. The heating element may also be an active component. Power to heat converter 1704 may be a part of an integrated circuit or a chip.

Temperature sensor 1708 in the same integrated circuit is used to measure the temperature of the integrated circuit (chip). According to one implementation of the present invention, the heating element and temperature sensor may be disposed in a microstructure such as a membrane or a cantilever beam, manufactured by a micromachining technology.

Output of temperature sensor 1708 is coupled to one input of comparator 1710. Reference generated by controller 1714 is coupled to another input of comparator 1710. Output of comparator 1710, which is a PWM signal, is coupled to DC to PWM converter 1703. As soon as the measured temperature by temperature sensor 1708 exceeds a predetermined value, set by the reference, the output of the comparator switches off DC power source 1702. As a result, power to heat converter 1704 does not receive any power and the output of temperature sensor 1708 starts to drop. As soon as the output is below the reference, the output of comparator 1710 switches on DC power source to power to heat converter 1704. The temperature of the chip or the microstructure will oscillate around a small value. The power required to maintain the predetermined value of the temperature is determined by the reference and also by a resistance of heat transfer from the unit to the ambient. In one aspect, the reference is determined by the ambient temperature measured by ambient temperature sensor 1716.

1. A display system for an electronic apparatus comprising:
a. a display layer;
b. a plurality of temperature sensors disposed in a plurality of substrate units beneath the display layer, said plurality of temperature sensors pertaining to determining temperature distribution across said substrate units according to a predetermined frequency; and
c. a means for generating a control signal in response to changes of the temperature distribution.

2. The system as recited in claim 1, wherein said plurality temperature sensors are configured in a two dimensional array.

3. The system as recited in claim 1, wherein measured temperature distributions are transmitted to a processor of the electronic apparatus.

4. The system as recited in claim 1, wherein said temperature sensors further comprises infrared sensors.

5. The system as recited in claim 1, wherein said system further comprises a temperature sensor pertaining to measuring ambient temperature.

6. The system as recited in claim 1, wherein said electronic apparatus further comprises a wearable computing and communication device.

7. The system as recited in claim 1, wherein said control signal further comprises a signal pertaining to triggering redisplaying at least one displayed item with a larger size.

8. A display system for an electronic apparatus comprising:
a. a display layer;
b. a heat resistance measurement layer comprising a plurality of units, each of the units further comprising a plurality of temperature sensors and a plurality of heating elements;
c. a means for sustaining temperature of each of the units to a predetermined level above a measured ambient temperature; and
d. a means for generating a control signal in response to measured changes of the resistance of heat transfer in response to contactless movement of an object or a finger.

9. The system as recited in claim 8, wherein said plurality of units are thermally isolated.

10. The system as recited in claim 8, wherein said heat resistance measurement layer is disposed beneath said display layer.

11. The system as recited in claim 8, wherein said system further comprises a means for determining powers required to sustaining the predetermined temperature levels.

12. The system as recited in claim 8, wherein the temperature sensor and the heating element in each of said units is integrated in a single substrate.

13. The system as recited in claim 8, wherein said electronic apparatus further comprises a wearable computing and communication device.

14. The system as recited in claim 13, wherein said heat resistance measurement sheet comprises a single semiconductor chip.

15. The system as recited in claim 14, wherein said semiconductor chip further comprises silicon on insulator type of substrate.

16. The system as recited in claim 8, wherein said system further comprises an ambient temperature sensor.

17. The system as recited in claim 8, wherein said control signal further comprises a signal pertaining to triggering redisplaying at least one displayed item with a larger size.

18. A display system for an electronic apparatus comprising:
a. a display layer;
b. a position sensing system disposed beneath said display layer; and
c. a means for generating a control signal in response to signals generated by said position sensing system.

19. The system as recited in claim 18, wherein said position sensing system further comprises a heat resistance measurement layer including a plurality of temperature sensors and a plurality of heating elements.

20. The apparatus as recited in claim 18, wherein said position sensing system further comprises ultrasonic sensors including a plurality of sound generating units and a plurality of sound receiving units.
